(19) United States
(12) Patent Application Publication
(10) Pub. No.: US 2018/0218329 A1
(43) Pub. Date: Aug. 2, 2018

(54) RECOMMENDING FUTURE CAREER PATHS BASED ON HISTORIC EMPLOYEE DATA

(71) Applicant: INTERNATIONAL BUSINESS MACHINES CORPORATION, Armonk, NY (US)

(72) Inventors: Hemanth Kumar Choudhary Kadambala, Visakhapatnam (IN); Prabhuranjan Parhi, Visakhapatnam (IN)

(21) Appl. No.: 15/421,967

(22) Filed: Feb. 1, 2017

(51) Int. Cl. G06Q 10/10; G06Q 10/06; G06N 99/00

(52) U.S. Cl. CPC G06Q 10/1053; G06Q 10/06398; G06Q 50/01; G06N 99/005; G06Q 10/063112

(57) ABSTRACT

Embodiments of the present invention disclose a method, computer system, and a computer program product for recommending a career path within an organization for a candidate. The present invention may include collecting a plurality of organization data. The present invention may include collecting a plurality of employee data. The present invention may include collecting a plurality of candidate data. The present invention may include determining a plurality of career paths. The present invention may include determining a plurality of top performer attributes. The present invention may include mapping the determined plurality of top performer attributes to the plurality of career paths. The present invention may include determining a plurality of candidate attributes based on the collected plurality of candidate data. The present invention may include determining at least one recommended career path based on comparing the determined plurality of candidate attributes with the plurality of top performer attributes.

### BACKGROUND

The present invention relates generally to the field of computing, and more particularly to social analytics.

Many people, when faced with deciding a career path out of multiple choices, become confused determining the best career path to take. In some instances, other career paths unbeknownst to an individual may be available that may be a better fit for a person within an organization. Since many people rely on instincts and self-analysis based on incomplete facts, people may not make optimal career choices.

### SUMMARY

Embodiments of the present invention disclose a method, computer system, and a computer program product for recommending a career path within an organization for a candidate. The present invention may include collecting a plurality of organization data associated with the organization. The present invention may also include collecting a plurality of employee data associated with the organization. The present invention may then include collecting a plurality of candidate data associated with the candidate. The present invention may further include determining a plurality of career paths based on the collected plurality of organization data. The present invention may also include determining a plurality of top performer attributes based on the collected plurality of employee data. The present invention may then include mapping the determined plurality of top performer attributes to the determined plurality of career paths. The present invention may further include determining a plurality of candidate attributes based on the collected plurality of candidate data. The present invention may also include determining at least one recommended career path based on comparing the determined plurality of candidate attributes with the determined plurality of top performer attributes.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for career path recommendation according to at least one embodiment;

FIG. 3 is an example career path determination flow diagram according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for recommending future career paths based on historic employee data. As such, the present embodiment has the capacity to improve the technical field of social analytics by mapping organization career path data and historical career data to a job candidate's profile data to generate a recommended career path choice for the job candidate. More specifically, machine learning may be used in conjunction with collecting data from external data sources, such as social media having career progression information and job postings that list job requirements. Additionally, machine learning may be used to deduce career progression options within an organization by examining historic Human Resources Management System (HRMS) data, performance data, successful career path data, and education and skills requirements. Thereafter, the career progression data may be combined with external data and compared with a job candidate's personal profile. Furthermore, the candidate's data may be compared with the profiles of individuals that were successful in the available career paths. Then, based on the data collected and compared, the career paths that may be best for the job candidate in the future may be determined and presented.

The present embodiment provides distinct advantages by being a truly data and metric driven process to determine and recommend a career path. The career paths are determined in a manner that provides career paths that are time-tested and derived from past trends within an organization. Thus, guessing and instinctual decisions may be replaced with data-driven career path recommendations to the organization and candidate.

As described previously, many people, when faced with deciding a career path out of multiple choices, become confused determining the best career path to take. In some instances, other career paths unbeknownst to an individual may be available that may be a better fit for a person within an organization. Since many people rely on instincts and self-analysis based on incomplete facts, people may not make optimal career choices.

Therefore, it may be advantageous to, among other things, provide a way to collect and analyze data regarding career paths within an organization, profile data for successful employees in various career paths, and job candidate profile data to recommend successful future career paths for job candidates based on historical data.

According to at least one embodiment, historic data of employees from various human resources systems in a company (e.g., applicant tracking system data, assessment results, performance data, Human Resource Information System (HRIS) data, survey data, product/engineering repositories and other web and social media contributions) may be used to determine past trends and patterns in the career progression of individuals. The collected historic data and organization-specific data (e.g., available career paths and requirements for each path) may be compared with existing employee and job candidate profile data to recommend future career paths within an organization. If a job candidate (e.g., prospective employee or existing employee) profile is determined to be similar to a successful existing or past employee, the career path of the successful employee may be recommended to the job candidate.

More specifically, career path recommendations may be used in the context of a new hire who has passed through various hiring processes, such as resume screening, assessments, and interviews. Based on the results of the various hiring processes, validated proof and proficiency levels may be obtained on multiple dimensions for the job candidate. For the hiring organization, a career roadmap may be generated and presented to the job candidate. The career roadmap may be determined by using internal organization data, such as culture derived from survey reports, challenges and opportunities, and outstanding needs within the organization. The organization's internal data together with a model giving insights into organizational aspects of the organization, such as culture (e.g., work hours and compensation), performance criteria (e.g., HRIS and performance/appraisal data), organization-specific skills and needs, organization weaknesses, business model and vision, and jobs and positions within the organization may be derived from historic data. Historic data of an organization may be sourced from a variety of systems, such as HRIS, applicant tracking system (ATS) and other hiring systems, onboarding data, assessments, and survey data. The organization-specific data from various sources may be collected and analyzed together to build a success profile. The success profile may describe a model of the organization and the aspects of a successful candidate in the available career paths.

Additionally, data about the job candidate, whether a new hire or an existing employee, may be identified and collected. Since a candidate's resume may not be accurate, and may not include any indication of proficiency levels, additional data beyond a resume may be collected. Data indicating the candidate's actual performance may be searched for and retrieved. Candidate performance data may also be found, for example, from searching the candidate's social media postings, blogs, participation in technical forums, assessment results of skills and behavior, and interview findings. Thus, candidate performance data may be obtained that indicates the candidate's performance in multiple dimensions. Furthermore, candidate historical data, such as education, past employment, experience and skills along with public domain data may then be mapped to the organization-specific data. Based on the mapping of the candidate skills, history, and proficiency to the organization's model and needs, future career path recommendations may be generated as career paths or roadmaps for candidates.

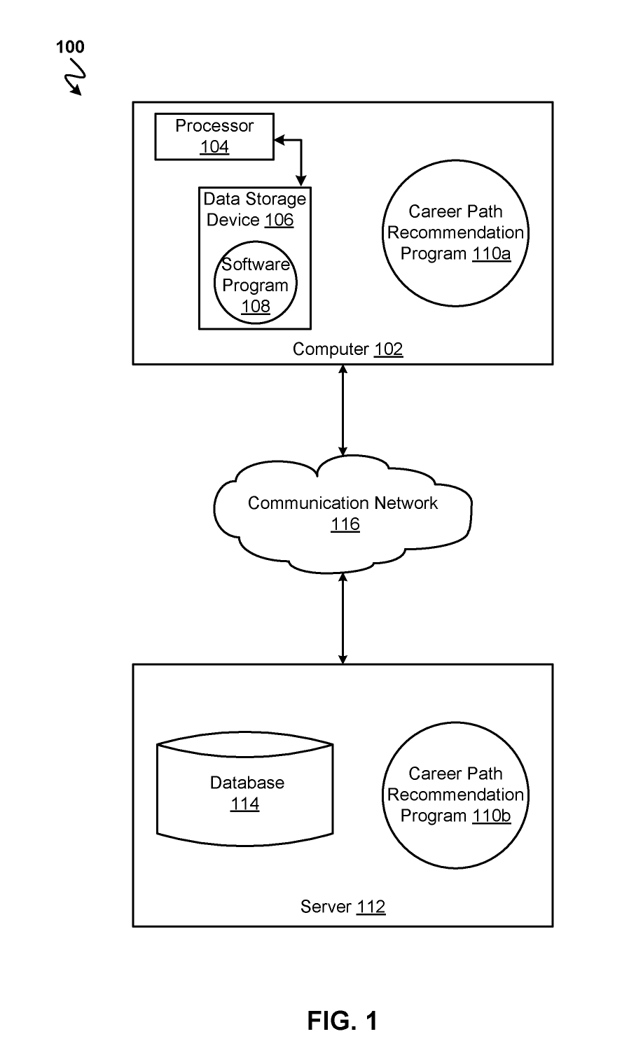

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a career path recommendation program 110a. The networked computer environment 100 may also include a server 112 that is enabled to run a career path recommendation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

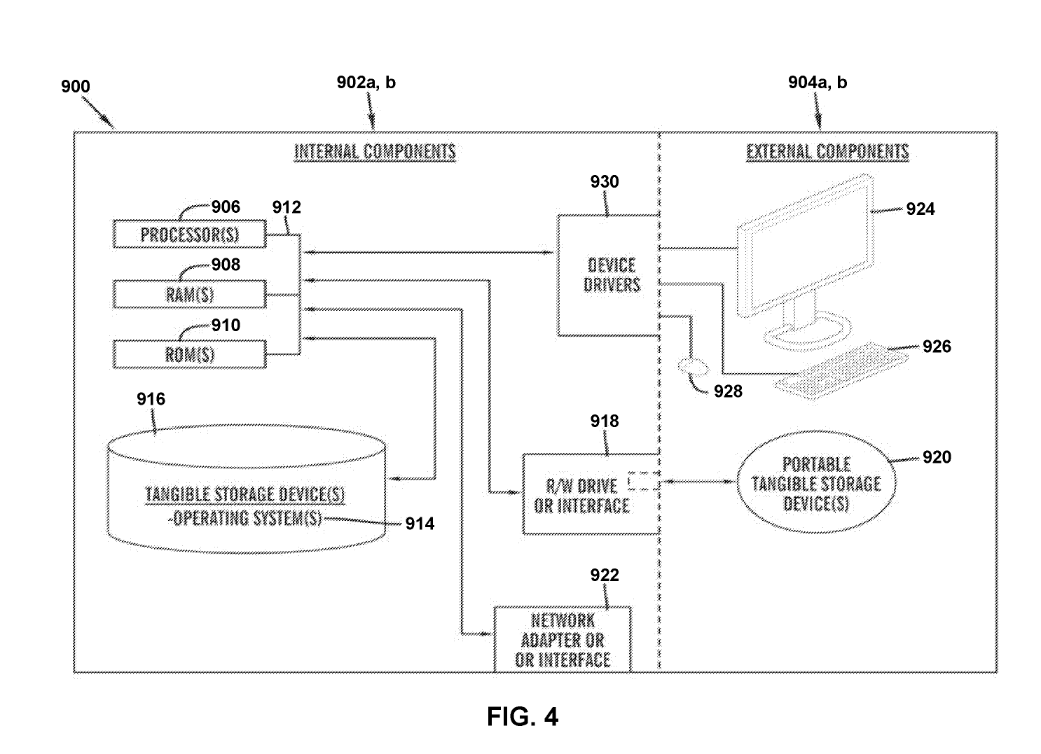

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the career path recommendation program 110a, 110b may interact with a database 114 that may be embedded in various storage devices, such as, but not limited to a computer/mobile device 102, a networked server 112, or a cloud storage service.

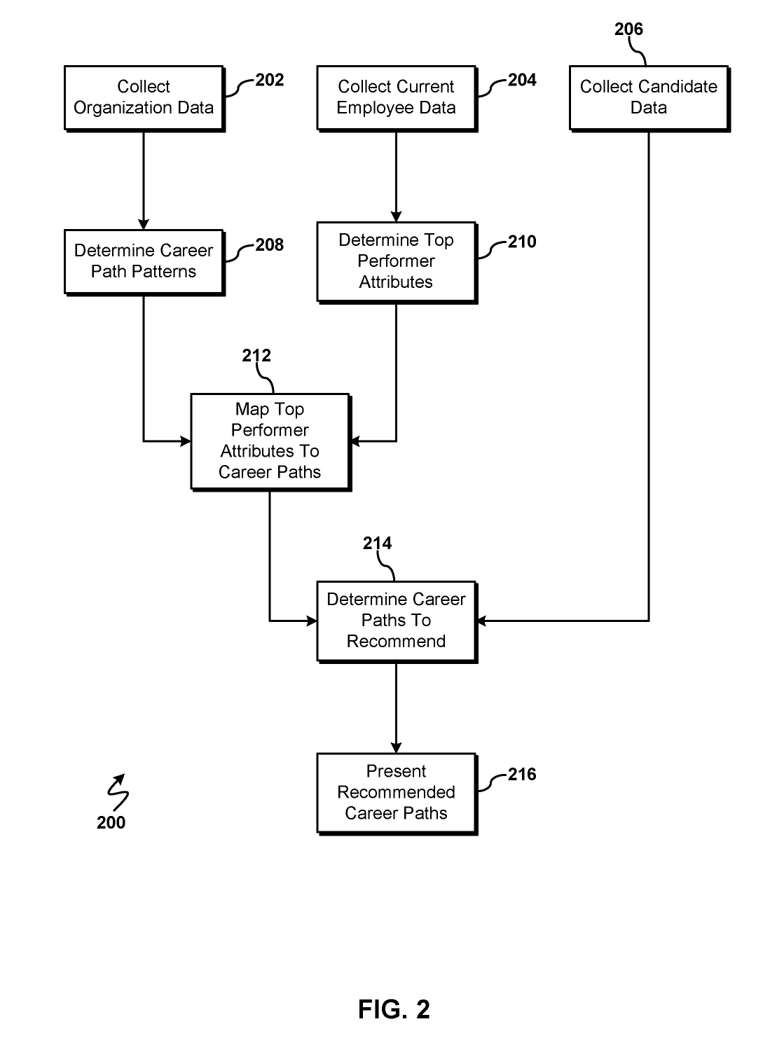

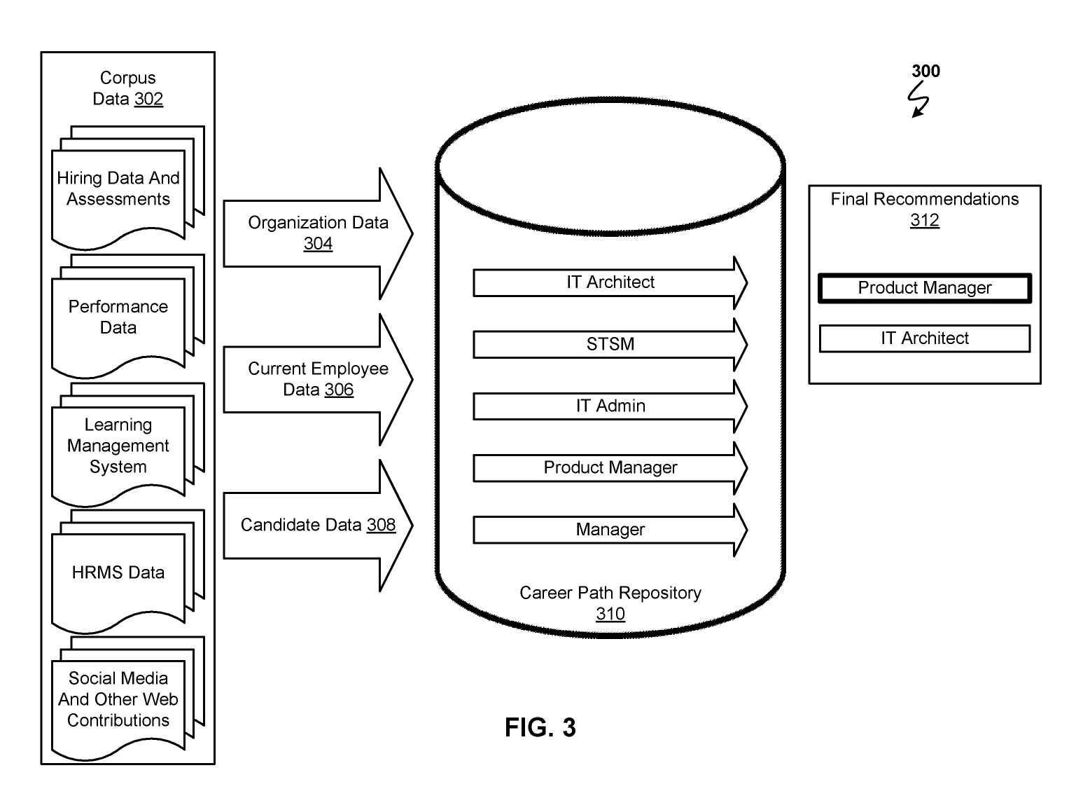

According to the present embodiment, a user using a client computer 102 or a server computer 112 may use the career path recommendation program 110a, 110b (respectively) to collect organization data and candidate data, determine career paths within an organization, identify successful employees in the determined career paths, and then recommend career paths with successful employees that are similar to a job candidate. The career path recommendation method is explained in more detail below with respect to FIGS. 2 and 3.

Referring now to FIG. 2, an operational flowchart illustrating the exemplary career path recommendation process 200 used by the career path recommendation program 110a and 110b according to at least one embodiment is depicted. Collection of organization data (at 202), current employee data (at 204), and candidate data (at 206) may occur concurrently by different program threads or at unique times.

At 202, organization data is collected. Data pertaining to an organization such as a business, non-profit, or government agency may be collected as a basis for determining, for example, the organization's career paths, positions, needs, and weaknesses. Organization data may include human capital management (HCM) data and HRMS data captured in various systems. Organization data may be collected from various databases (e.g., 114), other data repositories maintained by the organization, by third-parties storing the organization data, or from internet sources. Internet-based sources of organization data may include social media data and job posting services that list available positions and the requirements for the same. Some organization data, such as organization goals and needs may also be inputted by human resource or other personnel. The collected organization data may then be stored in a data repository, such as a database 114, for later retrieval and processing.

Additionally, at 204, current employee data is collected. Current employee data may include background information, such as education and employment history relating to current and former employees. Furthermore, current employee data may be derived from hiring data, performance-related data, product and engineering repositories, organization learning management data, assessment data, and HRMS data. Survey data may also be collected that provides insights into the organization's culture (e.g., work and compensation). Current employee data may then be stored in a data repository, such as a database 114, for later retrieval and processing.

At 206, job candidate data is collected. Candidate data may be collected from candidate-provided data (e.g., resume, school transcripts), from web sources (e.g., blog comments, social media postings), and from assessments and reviews. Assessments and reviews may be sourced from within the organization if the job candidate is already an employee. For new-hire candidates, review data may be entered as the hiring process proceeds (e.g., feedback data from a job interview). The assessments and reviews may be used to validate the candidate's qualifications as noted on a resume and provide an indication of the candidate's proficiency in various skills. Validation data may also come from social media postings and profiles as well as journal articles and other sources. Additionally, candidate personality traits may be collected from user input or identified from other job candidate data. Candidate data may be organized as a profile indicating the candidate's attributes. The collected candidate data may then be stored in a data repository, such as a database 114, for later retrieval and processing.

After organization data is collected at 202, available career paths are determined at 208. Machine learning methods may be utilized to analyze the collected organization data to derive patterns indicating possible career paths. Additionally, current candidate data collected previously at 206 (and previous employee data) may be analyzed to determine career paths taken within the organization and before joining the organization. Based on the derived patterns, a graph structure may be created (e.g., through the use of machine learning) representing the possible career paths. The graph may be populated with nodes that represent individual job positions (e.g., program manager) and with edges representing career movement between any given two job positions (i.e., nodes). Data used to create the set of nodes in the graph representing job positions may, for example, come from job listings and position titles. Data used to create a set of edges within the graph may be derived from job posting prerequisites and from historical movement of employees from one position to another. For example, a graph may have nodes representing a software engineer, a product manager, and an information technology (IT) architect. The edges of the graph may be determined based on historical personnel movement. If employee Dan started as a software engineer and later became an IT architect, then an edge in the graph will span from the software engineer node to the IT architect node.

After current employee data is collected at 204, top performer attributes are determined at 210. Machine learning may be utilized to analyze the collected current employee data to derive patterns indicating the attributes associated with successful employees in various job positions within the organization. Employees may be identified as top performers or successful employees based on assessments, achievements, bonuses, and promotions indicative of success. The attributes of employees that performed well in a position may be associated with the graph node representing the position. For example, John is identified as a top performing product manager within organization XYZ based on performance reviews. Thereafter, John's attributes A, B, and C will identified from within the collected current employee data and stored as top performer attributes in a data repository.

Then, at 212, top performer attributes are mapped to the determined career paths. The top performer attributes determined previously at 210 may be mapped to the job positions within the career path patterns determined previously at 208. The mapping may proceed by identifying the job position held (or previous job positions held) by a top performer and identifying the career path or paths that include the identified job position. Continuing the previous example, John's attributes A, B, and C are linked (i.e., mapped) to the node in the organization career graph that represents the product manager position.

After mapping top performer attributes to career paths at 212 and collecting candidate data at 206, career paths to recommend are determined at 214. Based on the candidate data collected previously at 206, a candidate profile indicating candidate attributes may be generated to include, for example, the skills, education, personality traits, job history, and proficiency of the candidate. Thereafter, the candidate's attributes indicated in the candidate profile may be compared against the top performer attributes determined previously at 210. Known similarity metrics may be used to determine how similar the candidate's attributes are to certain top performer attributes associated with the nodes in the organization graph. A career path may then be determined based on the nodes and edges within the graph by selecting a first node that best matches the candidate's attributes. Thereafter, from the edges connected to the first node, an adjacent node may be selected based on the similarity of the candidate's attributes to the top performer attributes associated with the adjacent node. Additional iterations of the process may produce a set of nodes representing positions within the organization that indicates a career path for the candidate. The career path (i.e., list of nodes) may then be stored in a data repository, such as a database 114. Additional career paths may be generated in a like manner to generate additional unique career paths. Once the career paths have been determined, each path may have a score assigned indicating the likelihood for future success of the candidate based on the similarity of the candidate's attributes to the attributes of top performers at each node (i.e., position) in the career path. The career paths may then be ordered according to the assigned score and a threshold number (e.g., three career paths) may be selected having scores indicating that the candidate will most likely be successful. According to at least one other embodiment, any number of career paths may be select provided the score assigned to the path exceeds a threshold value. The threshold number of career paths may then be designated as the recommended career paths.

According to at least one other embodiment, attributes of multiple top performers for a job position may be compared and common attributes may be weighted more heavily than attributes that may not be shared amongst top performers. For example, in addition to John, Marsha and Alex are also identified as top performers as product managers. If John has attributes A, B, and C; Marsha has attributes B, D, and E; and Alex has attributes B, D, and F, then attribute B will be weighted the greatest since it is present in all three top performers. Attribute D would be weighted less than attribute B since that attribute is associated with only Marsha and Alex. Attributes A, C, E, and F would be weighted equally as the least weighted attributes since each attribute was only associated with one top performer. Thus, if a candidate C₁ has attribute D and candidate C₂ has attribute B, the score indicating success for candidate C₂ as a product manager will be higher than for candidate C₁.

Then, at 216, recommended career paths are presented. The resulting recommended career paths may then be presented to a recruiter, human resource personnel, current employee, or job candidate. Recommended career paths may be presented within a graphical user interface (GUI) or other visual or textual representation. The recommended career paths may be displayed on a screen within a GUI that the user may interactively use to see job descriptions of positions, skills, compensation, assigned success scores, and the like within the recommended career paths.

Referring now to FIG. 3, an example career path determination flow diagram 300 according to at least one embodiment is depicted. Corpus data 302 may be searched to collect organization data 304 associated with organization XYZ as described previously at 202, current employee data 306 associated with current and former employees of organization XYZ as described previously at 204, and candidate data 308 associated with candidates applying for a job within organization XYZ as described previously at 206. Corpus data 302 may be derived from a variety of sources as described previously. From the corpus data 302, career path patterns may be determined and further used to determine career paths within organization XYZ as described previously at 208. If organization XYZ posts job listings to job boards indicating an available position as a product manager listing required skills and work experience as a product designer, that job listing data is collected as described previously at 202 and after machine learning analysis, a product manager career path is identified as described previously at 208. The product manager career path is then stored in the career path repository 310. A career path for an information technology (IT) architect may also be identified and stored in the career path repository 310.

From the current employee data 306, top performers and associated attributes are identified as described previously at 210. If the corpus data 302 contains data indicating that John is a top performer at organization XYZ, John's attributes A, B, and C will be identified and retrieved from the corpus data 302. Since John is a product manager, John's attributes A, B, and C will be mapped to the product manager career path as described previously at 212. Another top performer, Jake, with attributes D, E, and F may be mapped to the IT architect career path.

Candidate data 308 relating to job candidate Lisa, who is seeking a job at organization XYZ, will also be collected from the corpus data 302 as described previously at 206. Lisa's candidate data 308 is analyzed and attributes A, C, and D are identified based on the collected candidate data 308. Based on Lisa's attributes, the product manager career path is selected as one of the final recommendations 312 since Lisa's attributes A and C match two attributes of the top performer associated with the product manager career path. Furthermore, Lisa's attribute D matches an attribute for a top performer associated with the IT architect career path, thus the IT architect career path is also selected as one of the final recommendations 312 as described previously at 214. Since Lisa has more attributes matching a top performer of a product manager, the product manager career path is highlighted over the other recommended IT architect career path. Then, the final recommendations 312 may be presented as described previously at 216 to job candidate Lisa.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements. For example, career path trends may also be generated using analytics to process the collected career path data by weighting the collected career path data temporally. As such, skills and proficiency levels possessed by recent individuals in a given position on a career path may be more heavily weighted than by individuals that held a position years ago. Furthermore, organizational data collected regarding the organization's needs or goals may be used to influence the career path trends to meet the changing needs of the organization.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 4. Each of the sets of internal components 902a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the career path recommendation program 110a in client computer 102, and the career path recommendation program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the career path recommendation program 110a and 110b can be stored on one or more of the respective portable computer-readable tangible storage devices 920, read via the respective R/W drive or interface 918, and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the career path recommendation program 110a in client computer 102 and the career path recommendation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the career path recommendation program 110a in client computer 102 and the career path recommendation program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models Are As Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

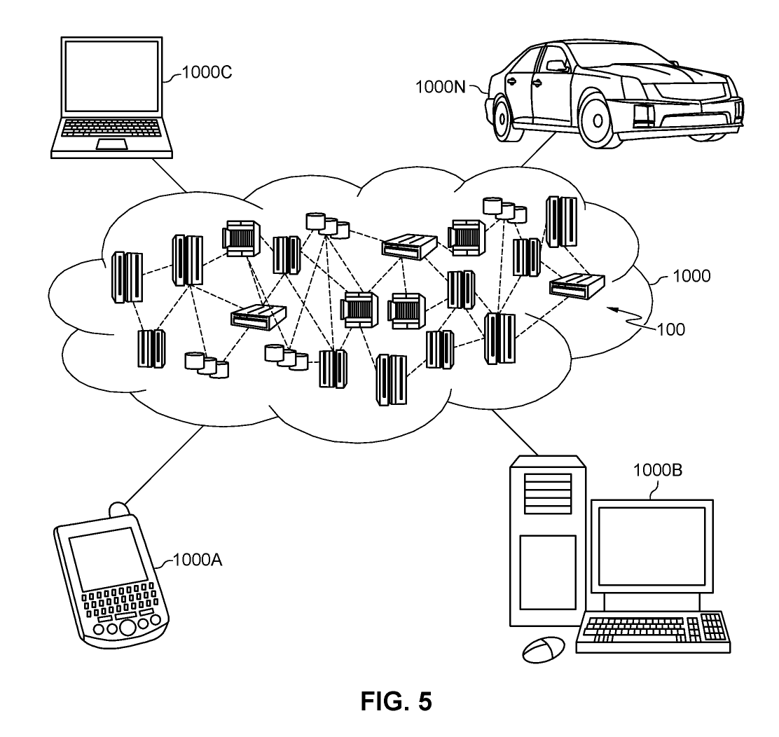

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

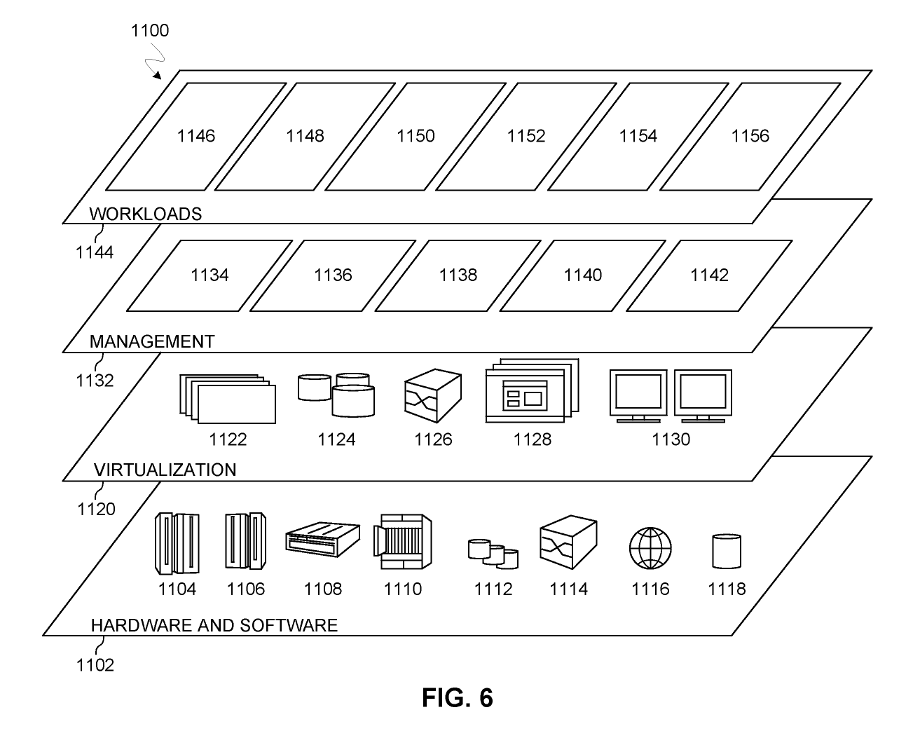

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and career path recommendation 1156. A career path recommendation program 110a, 110b provides a way to determine recommended career paths within an organization for a job candidate.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for recommending a career path within an organization for a candidate, the method comprising:
collecting, by a processor, a plurality of organization data associated with the organization;
collecting a plurality of employee data associated with the organization;
collecting a plurality of candidate data associated with the candidate;
determining a plurality of career paths based on the collected plurality of organization data;
determining a plurality of top performer attributes based on the collected plurality of employee data;
mapping the determined plurality of top performer attributes to the determined plurality of career paths;
determining a plurality of candidate attributes based on the collected plurality of candidate data; and
determining at least one recommended career path based on comparing the determined plurality of candidate attributes with the determined plurality of top performer attributes.

2. The method of claim 1, wherein the collected plurality of employee data includes data from a plurality of current employees and a plurality of past employees.

3. The method of claim 1, further comprising:
determining career path trends based on the determined plurality of career paths and the collected plurality of organization data.

4. The method of claim 1, wherein determining the recommended career path based on comparing the determined plurality of candidate attributes with the determined plurality of top performer attributes further comprises:
generating a candidate profile having a plurality of candidate skills, a plurality of candidate education, and a plurality of candidate proficiency levels;
generating an employee profile for each employee within the organization having a plurality of employee skills, a plurality of employee education, and a plurality of employee proficiency levels; and
comparing the plurality of candidate skills to the plurality of employee skills, comparing the plurality of candidate education to the plurality of employee education, and comparing the plurality of candidate proficiency levels to the plurality of employee proficiency levels for each employee within the organization.

5. The method of claim 1, further comprising:
presenting the determined at least one recommended career path to the candidate.

6. The method of claim 1, wherein determining the plurality of career paths based on the collected plurality of organization data comprises using machine learning to derive the plurality of career paths from the collected plurality of organization data, and wherein determining the determined plurality of top performer attributes based on the collected plurality of candidate data comprises using machine learning to derive the determined plurality of top performer attributes from the collected plurality of employee data.

7. The method of claim 1, wherein collecting the plurality of organization data associated with the organization comprises collecting data selected from the group consisting of a plurality of human resource management system data, a plurality of organization hiring data, a plurality of assessment data, a plurality of survey data, a plurality of web site job postings, and a plurality of social media data.

8. A computer system for recommending a career path within an organization for a candidate, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
collecting a plurality of organization data associated with the organization;
collecting a plurality of employee data associated with the organization;
collecting a plurality of candidate data associated with the candidate;
determining a plurality of career paths based on the collected plurality of organization data;
determining a plurality of top performer attributes based on the collected plurality of employee data;
mapping the determined plurality of top performer attributes to the determined plurality of career paths;
determining a plurality of candidate attributes based on the collected plurality of candidate data; and
determining at least one recommended career path based on comparing the determined plurality of candidate attributes with the determined plurality of top performer attributes.

9. The computer system of claim 8, wherein the collected plurality of employee data includes data from a plurality of current employees and a plurality of past employees.

10. The computer system of claim 8, further comprising:
determining career path trends based on the determined plurality of career paths and the collected plurality of organization data.

11. The computer system of claim 8, wherein determining the recommended career path based on comparing the determined plurality of candidate attributes with the determined plurality of top performer attributes further comprises:
generating a candidate profile having a plurality of candidate skills, a plurality of candidate education, and a plurality of candidate proficiency levels;
generating an employee profile for each employee within the organization having a plurality of employee skills, a plurality of employee education, and a plurality of employee proficiency levels; and
comparing the plurality of candidate skills to the plurality of employee skills, comparing the plurality of candidate education to the plurality of employee education, and comparing the plurality of candidate proficiency levels to the plurality of employee proficiency levels for each employee within the organization.

12. The computer system of claim 8, further comprising:
presenting the determined at least one recommended career path to the candidate.

13. The computer system of claim 8, wherein determining the plurality of career paths based on the collected plurality of organization data comprises using machine learning to derive the plurality of career paths from the collected plurality of organization data, and wherein determining the determined plurality of top performer attributes based on the collected plurality of candidate data comprises using machine learning to derive the determined plurality of top performer attributes from the collected plurality of employee data.

14. The computer system of claim 8, wherein collecting the plurality of organization data associated with the organization comprises collecting data selected from the group consisting of a plurality of human resource management system data, a plurality of organization hiring data, a plurality of assessment data, a plurality of survey data, a plurality of web site job postings, and a plurality of social media data.

15. A computer program product for recommending a career path within an organization for a candidate, comprising:
one or more computer-readable storage medium and program instructions stored on at least one of the one or more tangible storage medium, the program instructions executable by a processor, the program instructions comprising:
program instructions to collect a plurality of organization data associated with the organization;
program instructions to collect a plurality of employee data associated with the organization;
program instructions to collect a plurality of candidate data associated with the candidate;
program instructions to determine a plurality of career paths based on the collected plurality of organization data;
program instructions to determine a plurality of top performer attributes based on the collected plurality of employee data;
program instructions to map the determined plurality of top performer attributes to the determined plurality of career paths;
program instructions to determine a plurality of candidate attributes based on the collected plurality of candidate data; and
program instructions to determine at least one recommended career path based on comparing the determined plurality of candidate attributes with the determined plurality of top performer attributes.

16. The computer program product of claim 15, wherein the collected plurality of employee data includes data from a plurality of current employees and a plurality of past employees.

17. The computer program product of claim 15, further comprising:
program instructions to determine career path trends based on the determined plurality of career paths and the collected plurality of organization data.

18. The computer program product of claim 15, wherein determining the recommended career path based on comparing the determined plurality of candidate attributes with the determined plurality of top performer attributes further comprises:
program instructions to generate a candidate profile having a plurality of candidate skills, a plurality of candidate education, and a plurality of candidate proficiency levels;
program instructions to generate an employee profile for each employee within the organization having a plurality of employee skills, a plurality of employee education, and a plurality of employee proficiency levels; and
program instructions to compare the plurality of candidate skills to the plurality of employee skills, comparing the plurality of candidate education to the plurality of employee education, and comparing the plurality of candidate proficiency levels to the plurality of employee proficiency levels for each employee within the organization.

19. The computer program product of claim 15, further comprising:
program instructions to present the determined at least one recommended career path to the candidate.

20. The computer program product of claim 15, wherein determining the plurality of career paths based on the collected plurality of organization data comprises using machine learning to derive the plurality of career paths from the collected plurality of organization data, and wherein determining the determined plurality of top performer attributes based on the collected plurality of candidate data comprises using machine learning to derive the determined plurality of top performer attributes from the collected plurality of employee data.
